(19) United States
(12) Patent Application Publication
(10) Pub. No.: US 2015/0178386 A1
(43) Pub. Date: Jun. 25, 2015

(54) System and Method for Extracting Measurement-Entity Relations

(71) Applicants: Heiner Oberkampf, Munchen (DE); Claudia Bretschneider, Munchen (DE); Sonja Zillner, Munchen (DE)

(72) Inventors: Heiner Oberkampf, Munchen (DE); Claudia Bretschneider, Munchen (DE); Sonja Zillner, Munchen (DE)

(21) Appl. No.: 14/250,326

(22) Filed: Apr. 10, 2014

(30) Foreign Application Priority Data
Dec. 19, 2013 (EP) 13198449.4

(51) Int. Cl. G06F 17/30; G06F 19/00

(52) U.S. Cl. CPC G06F 17/30734; G06F 19/32

(57) ABSTRACT

A system for extracting relations between measurements within an unstructured text and ontology concepts of at least one domain ontology stored in a domain ontology database is provided. The system includes an annotation unit adapted to process sentences of the unstructured text to derive tokens and measurements within the sentences. The derived tokens are annotated with ontology concepts mapped to the tokens. The system also includes a concept analyzing unit adapted to analyze, for each annotated sentence including at least one derived measurement, the annotated ontology concepts mapped to the derived tokens of the sentence to identify the ontology concepts related to the at least one derived measurement and to rank the identified related ontology concepts according to calculated relation strengths of the relations between the identified related ontology concepts and the respective measurement of the annotated sentence.

This application claims the benefit of EP 13198449.4, filed on Dec. 19, 2013, which is hereby incorporated by reference in its entirety.

### BACKGROUND

The present embodiments relate to a system and a method for extracting relations between measurements and entities within an unstructured text and ontology concepts of at least one domain ontology stored in a domain ontology database.

Unstructured texts such as reports or descriptions of machines may include measurements with numerical values. A typical example for such an unstructured text is a clinical report describing the current health status of a patient. Clinically relevant information may be presented in unstructured format such as a free text report made by a doctor. In most cases, the format of reports allows a free reporting style (e.g., that clinicians are free to document information they regard as relevant or important and may express their findings in any textual format). Unstructured clinical reports may include large amounts of information about the same or different patients. The information that is most relevant for clinical decisions are assertions about findings from examinations concerning the status of anatomical entities and corresponding size descriptions expressed as measurements. Measurements are one of the most important information objects contained in clinical reports. This is due to several reasons. Clinicians may only measure things of importance, and these measurements are comparable and thus provide valuable insights into the change of the patient's health status. However, the semantic information associated with measurement data contained in clinical reports is difficult to extract.

Information extraction as a task of Natural Language Processing is a technique that aims to find important information pieces in unstructured texts by transforming the data into a structured format. This enables an improved access to information enclosed in the unstructured texts. A commonly used technique facilitates knowledge bases such as controlled vocabularies or ontologies to recognize the entities listed in the text. In information extraction based applications, ontologies may be used to recognize and extract ontology concepts. This task is also referred to as entity recognition or semantic annotation. The subsequent analysis of the annotated entities and incorporation of corresponding ontology relations allows a deeper understanding of corresponding semantics.

Even though there are established information extraction techniques to detect and extract measurements in ontology concepts provided in unstructured texts, it is still difficult to identify the corresponding relations between the measurement and the entity the measurement is about.

In a conventional system, users such as clinicians may access information about measurements only within an extra manual effort (e.g., the users are to manually collect measurements from different reports in order to compare respective measurement values). Sometimes, users such as clinicians are to go back to the original data source such as an image and measure the entities again.

### SUMMARY AND DESCRIPTION

The scope of the present invention is defined solely by the appended claims and is not affected to any degree by the statements within this summary.

There is a need to provide a method and a system for extracting relations between measurements within an unstructured text and ontology concepts such as anatomical entities.

The present embodiments may obviate one or more of the drawbacks or limitations in the related art. In a first aspect, a system for extracting relations between measurements within an unstructured text and ontology concepts of at least one domain ontology stored in a domain ontology database is provided. The extraction system includes an annotation unit adapted to process sentences of the unstructured text to derive tokens and measurements within the sentences. The derived tokens are annotated with ontology concepts mapped to the tokens. A concept analyzing unit is adapted to analyze, for each annotated sentence including at least one derived measurement, the annotated ontology concepts mapped to the derived tokens of the sentence to identify the ontology concepts related to the at least one derived measurement and to rank the identified related ontology concepts according to the calculated relation strengths of the relations between the identified related ontology concepts and the respective measurement of the annotated sentence. In one embodiment, the annotation unit and/or the concept analyzing unit is or includes one or more computer processors.

In one embodiment of the system according to the first aspect of, the system further includes a knowledge model database storing at least one knowledge data model linked to the domain ontology. The knowledge data model indicates for some or all ontology concepts of the domain ontology at least one corresponding expected measurement range for measurement values of a typical measurement made in a specific state of the respective ontology concept.

In another embodiment of the system according to the first aspect, the concept analyzing unit is connected to the annotation unit to receive preprocessed sentences including at least one derived measurement and annotated ontology concepts from the preprocessing annotation unit and is further connected to the knowledge model database to apply the stored knowledge data model to identify the ontology concepts within each received sentence related to the at least one measurement within the same received sentence and to calculate the relation strengths of the relations between the identified ontology concepts and the respective measurement.

In one embodiment of the system according to the first aspect, the annotation unit includes an input interface adapted to receive text data of the unstructured text from a data memory permanently connected or temporarily connectable to the input interface of the system.

In another embodiment of the system according to the first aspect, the data memory is adapted to store a plurality of text documents each including unstructured text relating to investigated objects of interest including persons and/or machine components of a machine.

In a still further embodiment of the system according to the first aspect, several knowledge data models are stored in the knowledge model database for different types of investigated objects of interest including persons or patients of different age and/or gender or including technical objects of different types and/or versions.

In a further embodiment of the system according to the first aspect, the system further includes an output interface adapted to output ranked sets of identified related ontology concepts and the corresponding calculated relation strengths of the respective relations.

In one embodiment of the system according to the first aspect, the system further includes a grammar analyzing unit adapted to analyze each annotated sentence received from the preprocessing annotation unit using a set of grammar rules to derive a grammatical structure of the annotated sentence.

In another embodiment of the system according to the first aspect, the system further includes a selection unit adapted to evaluate for each annotated sentence the identified related ontology concepts ranked according to calculated relation strengths provided by the concept analyzing unit and/or the derived grammatical structure of the sentence provided by the grammar analyzing unit to select an ontology concept to which the at least one derived measurement within this annotated sentence refers.

In one embodiment of the system according to the first aspect, the selected ontology concepts are timestamped and stored along with their corresponding measurements for the respective investigated object in a memory.

In one embodiment of the system according to the first aspect, the system further includes an evaluation unit adapted to process selected timestamped ontology concepts of an investigated object of interest stored in the memory based on the corresponding measurements to evaluate changes of the selected ontology concepts of the object of interest over time in the past and/or to predict future changes of the selected ontology concepts of the object of interest.

In a still further embodiment of the system according to the first aspect, the at least one domain ontology stored in the domain ontology database includes a medical ontology of a medical domain comprising as ontology concepts anatomical and/or morphological entities.

In one embodiment of the system according to the first aspect, the unstructured text received by the annotation unit includes a clinical report concerning an investigated patient of interest read from a data memory.

In a further embodiment of the system according to the first aspect, a medical drug is applied by a drug application unit to the investigated patient of interest depending on the observed changes of the selected ontology concepts formed by an anatomical and/or morphological entity representing a functional organic part of the patient's body influenced by the applied medical drug.

In a second aspect, a machine including a memory that stores unstructured text describing the machine is provided. The machine is connected or connectable via an interface to a system according to the first aspect. The system is adapted to extract relations between measurements within an unstructured text and ontology concepts of at least one domain ontology stored in a domain ontology database. The extraction system includes an annotation unit adapted to process sentences of the unstructured text to derive tokens and measurements within the sentences. The derived tokens are annotated with ontology concepts mapped to the tokens. The extraction system also includes a concept analyzing unit adapted to analyze for each annotated sentence including at least one derived measurement the annotated ontology concepts mapped to the derived tokens of the sentence to identify the ontology concepts related to the at least one derived measurement and to rank the identified related ontology concepts according to the calculated relation strengths of the relations between the identified related ontology concepts and the respective measurement of the annotated sentence.

In a third aspect, a method for extracting relations between measurements within an unstructured text and ontology concepts of at least one domain ontology is provided. The method includes processing sentences of the unstructured text to derive tokens and measurements within the sentences, annotating the derived tokens of the processed sentences with ontology concepts mapped to the tokens, and analyzing the annotated ontology concepts of each sentence including at least one derived measurement to identify ontology concepts related to the derived measurements. The method also includes calculating relation strengths of relations between the identified related ontology concepts and the derived measurements, and ranking the identified related ontology concepts according to the calculated relation strengths.

In one embodiment of the method according to the third aspect, a knowledge data model is applied to each processed sentence including at least one derived measurement and annotated ontology concepts to identify ontology concepts related to the derived measurement and to calculate the relation strengths of the relations between the identified related ontology concepts and the derived measurement.

In another embodiment of the method according to the third aspect, the applied knowledge data model is stored in a knowledge model database and linked to the domain ontology. The knowledge data model indicates for some or all ontology concepts of the domain ontology at least one corresponding expected measurement range for measurement values of a typical measurement made in a specific state of the respective ontology concept.

In another embodiment of the method according to the third aspect, the annotated sentences are analyzed by using grammar rules to derive a grammatical structure of the annotated sentences.

In a still further embodiment of the method according to the third aspect, for each annotated sentence, identified related ontology concepts are ranked according to calculated relation strengths and/or the derived grammatical structure of the sentence to select an ontology concept to which the at least one derived measurement within the annotated sentence refers to.

In a further embodiment of the method according to the third aspect, the selected ontology concepts are timestamped and stored along with corresponding measurements for the respective investigated object in a memory and processed based on the corresponding measurements to evaluate changes of the selected ontology concepts of the object over time in the past and/or to predict changes of the selected ontology concepts of the investigated object in the future.

In a further embodiment of the method according to the third aspect, the at least one domain ontology includes a medical ontology of a medical domain having as ontology concepts anatomical and/or morphological entities. The unstructured text includes a clinical report concerning an investigated patient of interest.

In a still further embodiment of the method according to the third aspect, a medical drug is applied by a drug application unit to the investigated patient of interest depending on the observed changes of the selected ontology concepts formed by an anatomical and/or morphological entity representing a functional organic part of the patient's body influenced by the applied medical drug.

### BRIEF DESCRIPTION OF THE DRAWINGS

FIG. 1 shows a block diagram of one embodiment of a system for extracting relations between measurements within an unstructured text and ontology concepts of at least one domain ontology;

FIG. 2 shows a further block diagram for illustrating a further embodiment of the system for extracting relations between measurements within an unstructured text and ontology concepts of at least one domain ontology;

FIG. 3 shows a flowchart for illustrating one embodiment of a method for extracting relations between measurements within an unstructured text and ontology concepts of at least one domain ontology;

FIG. 4 shows a diagram of an exemplary graph of a domain ontology to illustrate the operation of a method and system; and

FIG. 5 shows a further exemplary graph illustrating the operation of a method and system for extracting relations.

### DETAILED DESCRIPTION

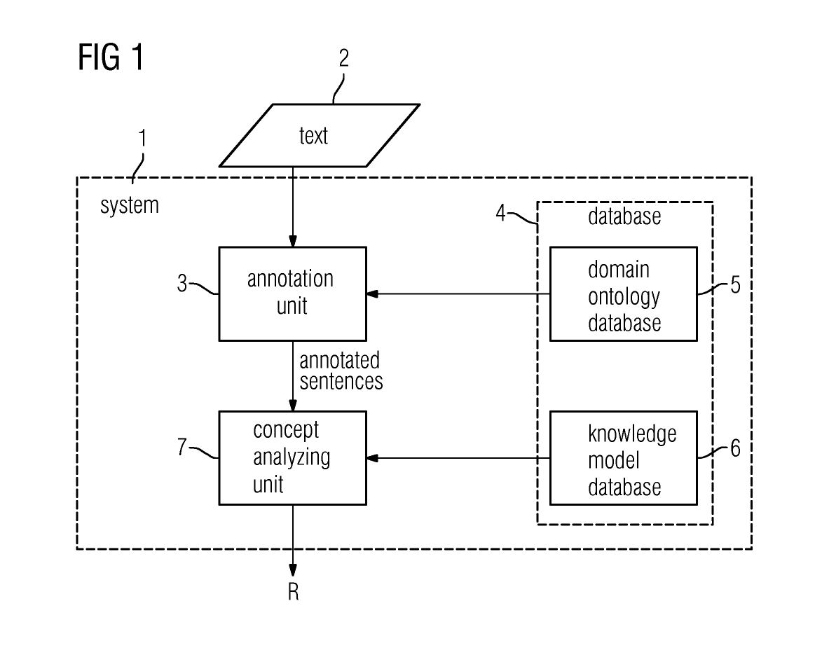

FIG. 1 shows a block diagram of an exemplary embodiment of a system for extracting relations between measurements within an unstructured text and ontology concepts of at least one domain ontology stored in a domain ontology database according to a first aspect. FIG. 1 shows the system 1 for extracting relations R having an input interface to input an unstructured text 2. The unstructured text may be stored in a memory and read by the system to a local memory. The unstructured text 2 may be, for example, a clinical report about a patient of interest dictated by a clinician or user such as a radiologist. For example, the radiologist looks at an image of a patient of interest such as a computer tomographic image. The clinician or user generates an unstructured text describing observations concerning the displayed image of the patient of interest. The system 1, as illustrated in FIG. 1, may be used for other applications as well. For example, the unstructured text may be stored in a memory of a machine or associated with a machine and describes operational functions or machine components of the respective machine.

The extraction system 1, as illustrated in FIG. 1, includes an annotation unit 3 adapted to process sentences S of the unstructured text to derive tokens t and measurements m within the sentences. The annotation unit 3 is adapted to annotate the derived tokens t with ontology concepts c mapped to the tokens t. The annotation unit 3 has access to a database 4 including at least one domain ontology database 5 and a knowledge model database 6. The annotation unit 3 outputs the annotated sentences S to a concept analyzing unit 7, as illustrated in FIG. 1. The concept analyzing unit 7 is adapted to analyze for each annotated sentence S including at least one derived measurement m the annotated ontology concepts c mapped to the derived tokens t of the sentence S to identify the ontology concepts c related to the at least one derived measurement m and to rank the identified related ontology concepts c according to the calculated relation strengths of the relations R between the identified related ontology concepts c and the respective measurement m of the annotated sentence S. The concept analyzing unit 7 may output the extracted relations R via an output interface of the system 1, as illustrated in FIG. 1.

The annotation unit 3 and the concept analyzing unit 7 may be directly connected to an internal database of the system 1 or may be connected via a data network to a remote database 4. The database 4 includes a knowledge model database 6 that stores at least one knowledge data model KDM linked to the domain ontology DO. The knowledge data model KDM indicates for some or all ontology concepts c of the domain ontology DO at least one corresponding expected measurement range for measurement values of a typical measurement m made in a specific state of the respective ontology concept.

The annotation unit 3 includes an input interface adapted to receive text data of the unstructured text from a data memory permanently connected or temporarily connectable to the input interface of the system 1. The data memory may be adapted to store a plurality of text documents each including unstructured text relating to investigated objects of interest. The investigated objects of interest may include persons such as patients and/or machine components of an investigated machine of interest.

The concept analyzing unit 7 is connected to the annotation unit 3 to receive preprocessed sentences S including at least one derived measurement m and annotated ontology concepts c from the preprocessing annotation unit 3. The concept analyzing unit 7 is further connected to the knowledge model database 6 to apply the stored knowledge data model KDM to identify the ontology concepts c within each received sentence S related to the at least one measurement m within the same sentence S and to calculate the relation strengths of the relations R between the identified ontology concepts of the respective measurement m.

In one embodiment, a plurality of (e.g., several) knowledge data models KDM may be stored in the knowledge model database 6 for different types of investigated objects of interest including persons or patients of different age and/or gender or including technical objects of different types and/or versions. The system 1 includes an output interface adapted to output ranked sets of identified related ontology concepts and the corresponding calculated relation strength of the respective relations R.

With the system 1 according to the first aspect, as illustrated in FIG. 1, the measurements m are assigned correctly to the entities or concepts the measurement is about. Consequently, a basis is established for an automatic inference of changes of the findings mentioned in different unstructured texts or reports. A single measurement datum of a measurement m may be about one or more entities e or concepts c. With the extraction system 1 according to the first aspect, a relation R between a measurement m and concepts c such as anatomical entities or morphological structures contained in a sentence S of an unstructured text such as a clinical report CR is established using information extraction techniques to annotate derived tokens t of the unstructured text such as a clinical report CR with ontology concepts c and to use a knowledge data model KDM linked to the domain ontology DO to analyze and identify for each annotated sentence S ontology concepts c related to at least one derived measurement m included in the annotated sentence S. The extraction system 1, as illustrated in FIG. 1, performs two subtasks (e.g., entity recognition and relation recognition). The recognition of entities such as anatomical entities and morphological structures based on a knowledge model encoded in ontologies is an established technique of semantic information extraction. The recognition of measurements in any form of unstructured text is covered by a well-known approach of regular expressions. This pattern-based technique may be used to detect any form of defined structure and a combination of alphanumeric characters in the unstructured text.

The concept analyzing unit 7 is adapted to identify and/or recognize relations between ontology concepts c (e.g., entities e such as anatomical entities) and measurements m within the annotated sentence S. In a possible embodiment, the concept analyzing unit 7 applies a grammar-based approach that is also referred to as dependency passing. In this embodiment, the concept analyzing unit 7 analyzes a grammatical structure of a received sentence S and concludes the linguistic relations between these elements. For example, in a sentence “mediastinal and axillary lymph nodes smaller than 1 cm,” analyzing the grammatical structure allows the recognition of the entities “mediastinal lymph node” and “axillary lymph node”. Further, the enumeration used shows that both recognized entities e or concepts c refer to the same measurement m. However, this technique may not be applied to very long sentences S or the resolution of relations between one entity e and multiple measurements m within one sentence. The concept analyzing unit 7 is adapted to identify ontology concepts c related to derived measurements m in longer sentences S with multiple measurements m.

The annotation unit 3 may use entity recognition enabling the information extraction system 1 to identify important information pieces in the received unstructured text. Semantic entity recognition describes the task of detecting concepts c or entities e in a text of a defined semantic class such as data values, names etc. The annotation unit 3 is adapted to identify anatomical entities and/or morphological structures and measurements m. In medical applications in order to detect the medical information pieces, one may use ontology based information instruction techniques. In a possible embodiment, a medical domain ontology is applied such as the RadLex ontology listing anatomical entities and morphological entities as a semantic class. The annotation unit 3 maps the entities e listed in the domain ontology DO to tokens or words in the unstructured text of the clinical report. Each mapping word or token is annotated with the respective ontology concept c. In order to detect measurements m, one may use pattern based techniques to detect adherences that express the defined combination of numbers and measurement units. The output of the annotation unit 3 in a possible use case may be a clinical report CR annotated with anatomical entities e, morphological structures and measurements m. Additionally, the annotation unit 3 may provide information on the sentence structure of sentences S within the clinical report CR. Each information may be associated with the enclosing sentence annotation.

The database 4 includes at least one domain ontology database 5. Databases may be, for example, XML, RDF or OWL databases. Ontologies offer a powerful way to represent a shared understanding of a conceptualization of a domain such as a medical domain. The domain ontology database 5 may define ontology concepts c and relations between them. For example, the subclass relation provides a hierarchical structure of the ontology concepts. Further, linguistic informations, such as labels, synonyms, abbreviations or definitions may be attached. In this way, the domain ontologies 5 provide a control vocabulary for the respective domain. In the biomedical domain, domain ontologies DO have a long tradition and a large and semantically rich domain ontologies DO exist. For example, the Bioportal includes an ontology repository or database for the biomedical domain containing more than 300 different domain ontologies DO, where 45 domain ontologies include more than 10,000 ontology concepts. Medical ontologies provide standardized labels for semantic annotation of patient data including reports such as clinical reports CR. Domain ontologies DO may cover, for example, a specific medical domain like specific diseases, symptoms, anatomy, radiology, phenotypes or medications. The domain ontologies DO stored in the domain ontology database 5 provide a comprehensive vocabulary for the respective domain and are suited for semantic annotation by the annotation unit 3. Additionally to a vocabulary, the domain ontology DO may provide knowledge of type and relations between the contained ontology concepts c or entities e. The concept analyzing unit 7 may use the hierarchical structure knowledge of the domain ontology DO to group and rank ontology concepts c. In order to better use the knowledge of the domain ontology DO, high level concepts may be explicitly labeled as being about anatomical entities or whether subclasses may or may not contain measurable entities e. The knowledge model stored in the knowledge model database 6 may include information data about typical measurements m of different anatomical concepts c or anatomical entities e or structures in a normal and abnormal status. For example, the knowledge data model KDM may include a typical size of certain organs or other anatomical entities e of clinical interest. Besides the anatomical entity or structure, the type of the measurement m may be further specified to better compare the information with actual measurements contained in the clinical report CR. For example, the type of measurement m may be specified as a volume, length or area. Additionally, a length measurement may be further specified by declaring the direction of the measurement as width, depth or height.

In one embodiment, a knowledge data model KDM is stored as a logical model and linked to the domain ontologies DO stored in the domain ontology database 5 and used for the annotation by the annotation unit 3. Thus, the information stored in the knowledge data model KDM may be applied to the annotations generated by the annotation unit 3. The information contained in the knowledge data model KDM may be patient specific and may depend, for example, on the age and gender of the respective patient of interest.

For each annotated sentence S containing a measurement m, the concept analysing unit 7 does output the measurement m and a set of entities for ontology concepts recognized in the sentence S. The concept-analysing unit 7 integrates the technical knowledge contained in the domain ontology DO and the knowledge model as well as the information about measurements m from correlating reports in order to decide which of the concepts or entities is described by the measurement m. The concept-analysing unit 7 may output a ranking of sets of entities or ontology concepts c the measurement m may be about with a corresponding confidence value. If all confidence values are low, the entity e measured may not be contained. The concept-analysing unit 7 depends on the annotations generated by the annotation unit 3.

If the set of entities or ontology concepts c recognized by the annotation unit 3 does not contain the entity e or ontology concept c described by the respective measurement m, the concept-analysing unit 7 is not able to find the entity e or ontology concept c, because the concept-analysing unit 7 only chooses between the recognized entities e or ontology concepts c. The correct entity for the ontology concept c may not be recognized in the following situations. For example, the measurement m and the respective ontology concept c may be separated by sentence boundaries. Even if the measurement m and ontology concept c or entity e occur in the same sentence S, the concept-analysing unit 7 may fail to recognize the ontology concept or entity if the domain ontology DO does not contain a corresponding concept c.

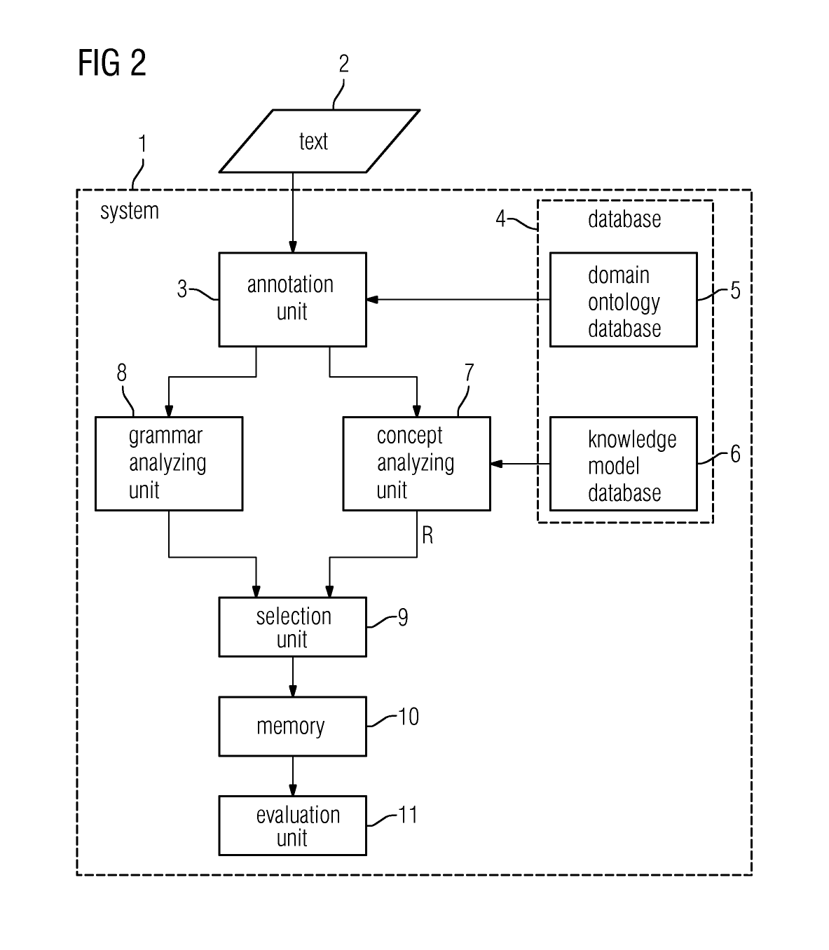

FIG. 2 shows a further block diagram for illustrating a further possible embodiment of the extraction system 1 according to the first aspect. As shown in FIG. 2, the extraction system 1 includes in the shown exemplary embodiment further units including a grammar-analysing unit 8. The grammar-analysing unit 8 is also connected to the annotation unit 3 and receives the annotated sentences S from the annotation unit 3. Accordingly, in the shown exemplary embodiment, the annotated sentences S generated by the annotation unit 3 are supplied to the grammar-analyzing unit 8 and to the concept-analyzing unit 7.

As shown in the exemplary embodiment, the grammar-analysing unit 8 is adapted to analyze each annotated sentence S received from the pre-processing annotation unit 3 using a set of grammar rules to evaluate grammatical structure of the annotated sentence S. The grammar-analysing unit 3 analyzes the grammatical structure of the annotated sentence S using the set of grammar rules. These grammar rules may be provided for the process and are tailored to the specific requirements of the text characteristics. This may be necessary, because the medical language used by users or clinicians includes, in many cases, telegraphic-style sentences that lack verbs and other fill-in words.

The applied grammar rules are used to parse the sentence structure and conclude on the word properties in the annotated sentence S. For example, it is determined which of the words represent the grammatical units' subject, predicate, object and which cases, persona, etc. the words describe. Using this grammatical information, a dependency graph of the words or tokens may be inferred in the respective sentence S. The dependency graph may also contain information on which anatomical entity or ontology concept c a contained measurement m refers.

In the embodiment shown in FIG. 2, the system further includes a selection unit 9. In the shown exemplary embodiment, the selection unit 9 is adapted to evaluate for each annotated sentence S the identified related ontology concepts c ranked according to the calculated relation strengths provided by the concept analysing unit 7 and/or to evaluate the derived grammatical structure of the respective sentence S provided by the grammar-analysing unit 8 to select the ontology concept c, for which the at least one derived measurement m within the annotated sentence S does refer.

In one embodiment, the selected ontology concepts c may be time-stamped and stored along with the corresponding measurements m with a respective investigated object in a memory 10 of the extraction system 1.

In the exemplary embodiment of FIG. 2, the extraction system 1 may also include an evaluation unit 11 that is adapted to process the selected time-stamped ontology concepts c of an investigated object of interest stored in the memory 10 based on the corresponding measurements to evaluate changes of the selected ontology concepts of the object of interest over time in the past and/or to predict future changes of the selected ontology concepts c of the object of interest. For example, the object of interest may be a patient of interest for which different clinical reports CR exist. An ontology concept c may be an anatomical entity e of the patient of interest, such as an organ. The different clinical reports CR may include measurements m concerning the organ of the patient. These measurements m may, for example, indicate the size of a specific organ. The evaluation unit 11 is adapted to automatically output measurements concerning the size of the organ within the patient of interest over time as indicated in the different clinical reports CR (e.g., measurements for every month within the last year). In this example, the doctor or physician does not have to read all clinical reports CR to find the size of the organ of interest but gets immediately and automatically, as an evaluation result, a diagram illustrating the development of the size of the organ over time. The evaluation unit 11 may be connected to a display of the extraction system 1.

In this embodiment, a diagram or graph indicating a measurement m of a selected ontology concept c, such as anatomical entity or organ over time, may be displayed to the clinician. In this way, the clinician may detect, for example, any significant changes of the ontology concept c, such as the organ, in response to a medical treatment of the patient of interest.

In a further embodiment, medical drugs may be applied to the patient using of a drug application unit depending on the observed changes of the selected ontology concepts c formed by an anatomical and/or morphological entity e representing a functional organic part of the patient's body influenced by the applied medical drug.

In a specific embodiment, the drug application unit may be controlled by the evaluation unit 11 and/or a user control interface provided for the clinician. This embodiment allows the impact of a medical drug treatment on an anatomical entity e or ontology concept c to be monitored using the measurements m related to the ontology concepts. In this way, the impact of medical drugs on a set of patients may be evaluated more rapidly, and the results become more reliable.

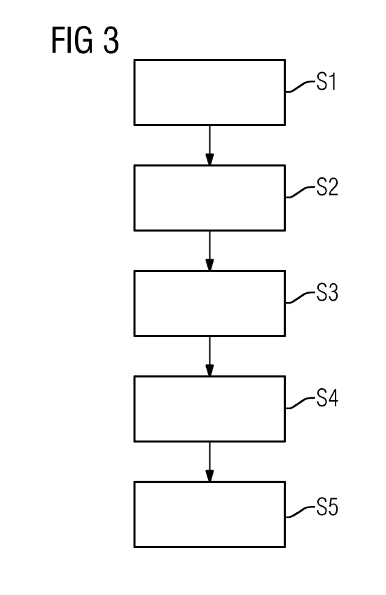

FIG. 3 is a flowchart of an exemplary embodiment of the method for extracting relations R between measurements m in an unstructured text, such as a chemical report CR and ontology concepts c of at least one domain ontology DO, such as a medical domain ontology. The method is implemented by a processor configured to operate pursuant to instructions stored on a non-transitory computer readable storage medium.

In act S1, sentences of the unstructured text are processed to derive tokens t and measurements m within the sentences S.

In act S2, the derived tokens t of the processed sentences are annotated with ontology concepts c mapped to the tokens t.

In act S3, the annotated ontology concepts c of each sentence S including at least one derived measurements m are analyzed to identify ontology concepts c related to the derived measurements m.

In act S4, the relation strength of the relations R between the identified related ontology concepts c and the derived measurements m are calculated.

In act S5, the identified related ontology concepts c are ranked according to the calculated relation strengths.

The method for extracting relations R between measurements m within an unstructured text and ontology concepts c of at least one domain ontology DO are described in the following in more detail.

Initially, the unstructured text is divided into sentences S containing tokens t such as words. The pre-processing of the received unstructured text may be performed by the annotation unit 3. The measurements m found in each sentence S may be annotated using predefined regular expressions. Anatomical entities, morphological structures, or any other ontology concept c may be annotated based on the domain ontology Do read from the domain ontology database 5. The annotation may be grouped by sentence boundaries. A measurement represented through a measurement value, measurement unit and measurement type as well as ontology concepts may be output (e.g., (RID13296, “lymph node”), (RID86, “spleen”) or (“RID38780, “lesion”), where “RID13296”, “RID86” or “RID38780” are RadLex ID numbers of the medical main ontology RadLex). The set of anatomical entities e or ontology concepts c may be denoted by E={e₁, e₂, . . . , eₙ}. For example, the sentence S “lymph node in abdomen area slightly enlarged with a size of 1.2 cm” provides the annotations: entities E={(RID13296, “lymph node”), (RID56, “abdomen”), (RID445, “abdominal lymph node”), (RID5791, “enlarged”)} with measurement value=“1.2”, measurement unit=“cm” and measurement type=length.

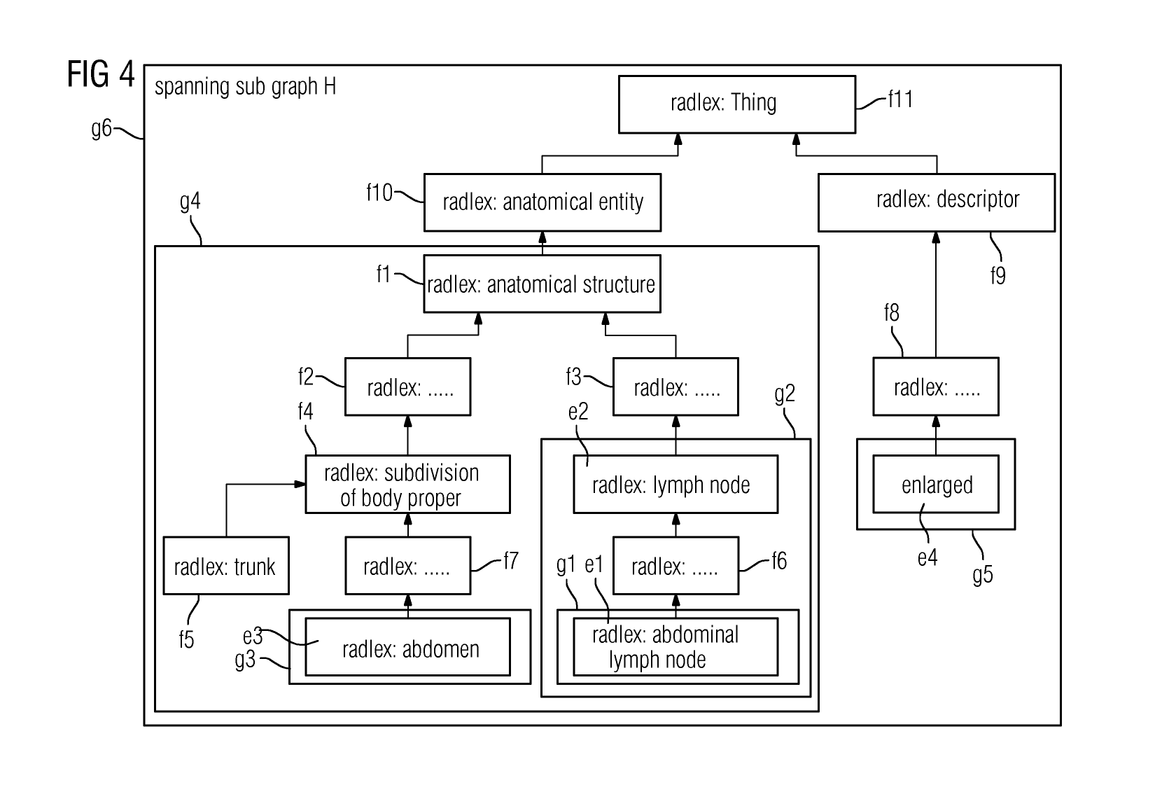

The following acts are performed by the concept analyzing unit 7. A task of the concept analysing unit 7 is to identify a subset E′ of E, where E′ contains exactly those entities e or anatomical concept c of E that are described by the measurement m. First groups g of entities e are created as illustrated, for example, in FIG. 4. A spanning subgraph H is generated. New entities e related to entities e of E are added by part-of relations. All subclass paths (e.g., concepts and relations) from the anatomical entities e of E that use the root elements of the domain ontology DO are added. The resulting subgraph is referred to as the spanning subgraph H.

The subgraph H group entities of E according to position in the subclass hierarchy are used. For each entity f of the graph H, subclasses are in the respective graph. This set may be denoted by subClass_{H(f)}. A group g is the intersection of subClass_{H(f)} with E, where the entity f is called the root concept of the respective group g. The set 6 of groups G is a subset of all groups g where a group g is in the set 6 of groups if the root concept of the group g is the least common ancestor of the group elements. For each entity e of E that forms a leaf node of the spanning graph H, there is a group g in the set of groups G that contains only the respective entity e (e.g., g={e}).

In a further act, a group tree T_{g} is created. Since a group g in the set of groups G is represented through a subset of E, a subsumption hierarchy of groups g may be created. In one embodiment, a distance measure d is calculated between groups g based on the position of the entities e or ontology concepts c contained in the respective group g. This may be performed by assigning distance values d to the edges of the subsumption hierarchy of groups. In one embodiment, a clustering index for the group g is calculated expressing how close the groups entities e are within the domain ontology DO. For example, it may be denoted whether the group g contains only anatomical entities e using the knowledge of the domain ontology DO. The group hierarchy with the associated information is referred to as a group tree T_{g}.

In a further act, structural information from the domain ontology DO is included. In one embodiment, the groups g including entities e that have relations to concept-like size descriptors or size-findings are classified. Respective information is assigned to the group g.

In a further act, information from the knowledge data model KDM is integrated. For all entities f contained in the spanning subgraph H, information about typical measurements is retrieved from the knowledge data model KDM if available. The typical measurement is compared with the measurement annotation. The result of the comparison is assigned to groups g for which the root element is subsumed by the entity f.

In a further act, the groups g are scored. This is performed if available information of measurements m from former reports is integrated. Further, this is performed if an entity e of the spanning subgraph H is measured before the groups containing the entity e are assigned with this information. In a further embodiment, based on the evidence values from the grammatical analysis and the information generated in the above steps, a final confidence value is calculated for each group g. A top-ranked group g is associated to the respective measurement m. If the confidence value for all groups g is below a certain threshold, this may indicate that a correct entity e or ontology concept c may have not been found (e.g., the correct entity e is not recognized by the annotation unit 3).

For example, if instructed text 2 includes a sentence S “lymph node in abdomen area slightly enlarged with a size of 1.2 cm,” this results in the following annotations: “lymph node”, “abdomen”, “abdominal lymph node”, “enlarged”, “1.2”, “cm”. FIG. 4 shows the corresponding resulting spanning subgraph H with entity groups g where:

Set of entities E={e₁, e₂, e₃, e₄}
Set of entities of H={e₁, e₂, e₃, e₄, f₁, . . . , f₁₁}
Set of groups G={g₁, g₂, g₃, g₄, g₆} with the following groups:
g₁={e₁}, g₂={e₁, e₂}, g₃={e₃}, g₄={e₁, e₂, e₃}, g₅={e₄}, g₆={e₁, e₂, e₃, e₄}, and with the following root elements:
root(g₁)=e₁, root(g₂)=e₂, root(g₃)=e₃, root(g₄)=f₁, root(g₅)=e₄ and root(g₆)=f₁₁,

The ontology concepts f are not mapped ontology concepts.

For example, the anatomical entity e₃ does form an ontology concept c of the medical domain ontology RadLex: The Abdomen concept e₃ may be mapped to the derived token t or word “abdomen” within the sentence S of the medical report CR, as cited above. In the same manner, the anatomical entity e₂ forming an ontology concept of the medical domain ontology RadLex “lymph node” may be mapped to the word or taken “lymph node” with the report sentence S. Ontology concepts c have a hierarchical relation to each other, as illustrated in FIG. 4. Each group g has a root element (e.g., the group g₄ has as root element, the ontology concept of the RadLex medical domain ontology “anatomical structure”).

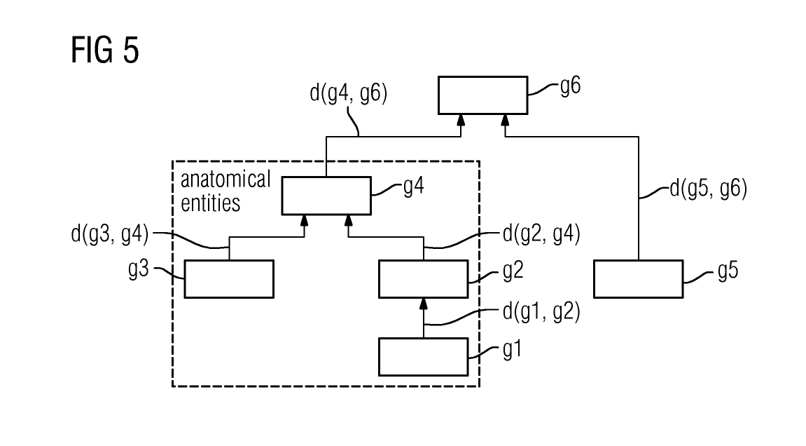

FIG. 5 shows an exemplary group tree T_{g} with distance values d for the given example. From the domain ontology DO, information is provided, which groups g contain anatomical entities e. In the given example, T_{g}={g₁, . . . , g₆} as subsumption relations (g₁, g₂), (g₁, g₄), (g₂, g₄), (g₃, g₄) . . . .

In the given example of FIG. 5, group g₆ is a meanless group, since a corresponding root entity is “Thing”, which forms a root concept of the entire domain ontology DO. Group g₅ does not represent anatomical entities. Further, there are more anatomical entities in the lymph node branch (group g₂) than in the branch where the anatomical entity “abdomen” is located. Given the knowledge data model KDM, while the size of lymph nodes may be in a range of 0 to 4 cm, the abdomen is a body region which size is not in that range. It may thus be inferred that the measurement m may be about the elements in group g₂ or group g₁. It may be further computed that groups g₁ and g₂ are really close in comparison to other groups. Since group g₁ and group g₂ have the same set of leaf nodes, it may be calculated that the “abdominal lymph node” is likely to be the anatomical entity e the measurement m is about.

The method according to one or more of the present embodiments using linguistic and/or ontology knowledge may be integrated into the resolution process. In further embodiments, a grammatical analysis is integrated with a formalized knowledge of domain ontologies and with factual knowledge of typical measurements in correlated unstructured texts. The concept analyzing unit integrates the results of different analyzing steps into a final confidence value for candidate entities (e.g., candidate ontology concepts c). The processed sentences S include measurements m describing one or more entities e or ontology concepts c.

The method is knowledge-driven. The knowledge of domain ontologies DO used for the annotation of the text is used in several acts of the detection process, as described above. Further, factual knowledge including a special knowledge data model KDM containing information about typical measurements m provided by examinations of patients is used. The factual knowledge is used in a final weighting process, since the final weighting process allows certain entities to be excluded.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for extracting relations between measurements within an unstructured text and ontology concepts of at least one domain ontology stored in a domain ontology database, the system comprising:
an annotation unit configured to process sentences of the unstructured text to derive tokens and measurements within the sentences, wherein the derived tokens are annotated with ontology concepts mapped to the tokens;
a concept analyzing unit configured to analyze, for each annotated sentence including at least one derived measurement, the annotated ontology concepts mapped to the derived tokens of the sentence to identify the ontology concepts related to the at least one derived measurement and to rank the identified related ontology concepts according to calculated relation strengths of relations between the identified related ontology concepts and the respective measurement of the annotated sentence.

2. The system of claim 1, further comprising a knowledge model database operable to store at least one knowledge data model linked to the at least one domain ontology,
wherein the knowledge data model indicates for some or all ontology concepts of the at least one domain ontology at least one corresponding expected measurement range for measurement values of a typical measurement made in a specific state of the respective ontology concept.

3. The system of claim 2, wherein the concept analyzing unit is connected to the annotation unit and is configured to receive preprocessed sentences including at least one derived measurement and annotated ontology concepts from the preprocessing annotation unit, and
wherein the concept analyzing unit is further connected to the knowledge model database and configured to apply the stored knowledge data model to identify the ontology concepts within each received sentence related to the at least one measurement within the same received sentence, and calculate the relation strengths of the relations between the identified ontology concepts and the respective measurement.

4. The system of claim 1, wherein the annotation unit comprises an input interface configured to receive text data of the unstructured text from a data memory permanently connected or temporarily connectable to the input interface of the system.

5. The system of claim 4, wherein the data memory is configured to store a plurality of text documents, each text document of the plurality of text documents comprising unstructured text relating to investigated objects of interest comprising persons, machine components of a machine, or the persons and the machine components of the machine.

6. The system of claim 5, further comprising a knowledge model database operable to store a plurality of knowledge data models for different types of investigated objects of interest, the different types of investigated objects of interest comprising persons or patients of different age, gender, or age and gender or comprising technical objects of different types, versions, or types and versions.

7. The system of claim 1, further comprising an output interface configured to output ranked sets of identified related ontology concepts and the corresponding calculated relation strengths of the respective relations.

8. The system of claim 1, further comprising a grammar analyzing unit configured to analyze each annotated sentence received from the preprocessing annotation unit using a set of grammar rules to derive a grammatical structure of the annotated sentence.

9. The system of claim 8, further comprising a selection unit configured to evaluate for each annotated sentence the identified related ontology concepts ranked according to calculated relation strengths provided by the concept analyzing unit, the derived grammatical structure of the sentence provided by the grammar analyzing unit, or the calculated relation strengths and the derived grammatical structure, to select an ontology concept to which the at least one derived measurement within this annotated sentence refers.

10. The system of claim 9, wherein the selected ontology concepts are timestamped and stored with corresponding measurements for the respective investigated object in a memory.

11. The system of claim 10, further comprising an evaluation unit configured to process selected timestamped ontology concepts of an investigated object of interest stored in the memory based on the corresponding measurements to evaluate changes of the selected ontology concepts of the object of interest over time in the past, to predict future changes of the selected ontology concepts of the object of interest, or a combination thereof.

12. The system of claim 1, wherein the at least one domain ontology stored in the domain ontology database comprises a medical ontology of a medical domain comprising as ontology concepts anatomical, morphological, or anatomical and morphological entities.

13. The system of claim 12, wherein the unstructured text received by the annotation unit comprises a clinical report concerning an investigated patient of interest read from a data memory.

14. The system of claim 12, wherein a medical drug is applicable by a drug application unit to the investigated patient of interest depending on observed changes of the selected ontology concepts formed by an anatomical, morphological, or anatomical and morphological entity representing a functional organic part of the body of the investigated patient of interest influenced by the applied medical drug.

15. A machine comprising:
a memory operable to store unstructured text describing the machine, wherein the machine is connected or connectable via an interface to a system for extracting relations between measurements within the unstructured text and ontology concepts of at least one domain ontology stored in a domain ontology database, the system comprising:
an annotation unit configured to process sentences of the unstructured text to derive tokens and measurements within the sentences, wherein the derived tokens are annotated with ontology concepts mapped to the tokens;
a concept analyzing unit configured to analyze, for each annotated sentence including at least one derived measurement, the annotated ontology concepts mapped to the derived tokens of the sentence to identify the ontology concepts related to the at least one derived measurement and to rank the identified related ontology concepts according to the calculated relation strengths of the relations between the identified related ontology concepts and the respective measurement of the annotated sentence.

16. A method for extracting relations between measurements within an unstructured text and ontology concepts of at least one domain ontology, the method comprising:
processing, by a processor, sentences of the unstructured text to derive tokens and measurements within the sentences;
annotating the derived tokens of the processed sentences with ontology concepts mapped to the tokens;
analyzing the annotated ontology concepts of each sentence including at least one derived measurement to identify ontology concepts related to the derived measurements;
calculating relation strengths of relations between the identified related ontology concepts and the derived measurements; and
ranking the identified related ontology concepts according to calculated relation strengths.

17. The method of claim 16, further comprising applying a knowledge data model to each processed sentence including at least one derived measurement and annotated ontology concepts to identify ontology concepts related to the derived measurement and to calculate the relation strengths of the relations between the identified related ontology concepts and the derived measurement.

18. The method of claim 17, further comprising storing the applied knowledge data model in a knowledge model database and linking the applied knowledge data model to the domain ontology,
wherein the knowledge data model indicates for some or all ontology concepts of the domain ontology at least one corresponding expected measurement range for measurement values of a typical measurement made in a specific state of the respective ontology concept.

19. The method of claim 16, wherein the annotated sentences are analyzed using grammar rules to derive a grammatical structure of the annotated sentences.

20. The method of claim 19, further comprising ranking, for each annotated sentence, identified related ontology concepts according to calculated relation strengths, the derived grammatical structure of the sentence, or a combination thereof, to select an ontology concept to which the at least one derived measurement within the annotated sentence refers.

21. The method of claim 20, further comprising:
timestamping the selected ontology concepts;
storing the timestamped selected ontology concepts with corresponding measurements for the respective investigated object in a memory; and
processing the timestamped selected ontology concepts based on the corresponding measurements to evaluate changes of the selected ontology concepts of the object over time in the past, to predict changes of the selected ontology concepts of the investigated object in the future, or a combination thereof.

22. The method of claim 16, wherein the at least one domain ontology comprises a medical ontology of a medical domain having as ontology concepts anatomical, morphological, or anatomical and morphological entities, and
wherein the unstructured text comprises a clinical report concerning an investigated patient of interest.

23. The method of claim 22, further comprising applying, using a drug application unit, a medical drug to the investigated patient of interest depending on observed changes of the selected ontology concepts formed by an anatomical, morphological, or anatomical and morphological entity representing a functional organic part of the body of the investigated patient of interest influenced by the applied medical drug.
